(19) United States
(12) Patent Application Publication
(10) Pub. No.: US 2021/0321628 A1
(43) Pub. Date: Oct. 21, 2021

(54) AUTOMATIC LOADING OF TREATMENT UNITS FOR FOODS

(71) Applicant: MIWE Michael Wenz GmbH, Arstein (DE)

(72) Inventors: Ronny Leppich-Rudloff, Karlstadt am Main (DE); Michael Ullrich, Eussenheim (DE); Adrian Issing, Wuerzburg (DE)

(73) Assignee: MIWE Michael Wenz GmbH, Arstein (DE)

(21) Appl. No.: 17/264,997

(22) PCT Filed: Jul. 23, 2019
(86) PCT No.: PCT/EP2019/069821

§ 371 Date: Feb. 1, 2021

(30) Foreign Application Priority Data
Aug. 3, 2018 (DE) 10 2018 118 975.3

(51) Int. Cl. A21B 3/07; A21B 7/00; B25J 18/02; B25J 5/00; G05D 1/02

(52) U.S. Cl. CPC A21B 3/07; A21B 7/00; G05D 2201/0216; B25J 5/007; G05D 1/0225; B25J 18/025

(57) ABSTRACT

The invention relates to an apparatus for treating foods, comprising at least one treatment unit (6, 21) which has at least one treatment chamber which is configured to receive product carriers with foods, and comprising at least one transport cart (1), which has rollers and at least one transport frame for a plurality of products, which can be introduced into the treatment chamber and which can be rolled into a first working position (20-24) on the treatment unit (6, 21). In order to further relieve the load on the personnel, the apparatus has at least one mobile drive unit, which is or can be coupled to the transport cart (1), and the drive unit has a navigation system and is configured to move the transport cart (1) automatically at least into the first working position (20-24).

### TECHNICAL FIELD

The system described herein relates to an apparatus and a method for the automatic loading of treatment units for foods.

### BACKGROUND OF THE INVENTION

Various systems for the automatic loading of treatment units for foods are known from the prior art. In particular for the loading of baking ovens, a multiplicity of apparatuses may have been proposed. The applicant back in 1999 proposed a baking trolley which can be pushed into a baking oven and bring the baking trays into the optimum position within the baking chamber of a baking oven by lifting and lowering them.

The document WO 2017/194403 A1 describes an apparatus for heat treatment of food products, in particular a baking oven with a baking chamber which is configured to receive product carriers with foods, and with a loading trolley for receiving at least one loading rack for a plurality of product carriers. The loading trolley is couplable to the heat treatment installation in order to move the loading rack with product carriers to and fro between the baking oven unit and the loading trolley. Catches are provided on the heat treatment installation, to which receptacles on the loading trolley are assigned, wherein a drive is provided for moving the catches vertically in order to couple the catches to the receptacles on the loading trolley from the entry position of the loading trolley by vertical lifting and to align the loading trolley with the catches on further lifting until said loading trolley reaches a defined end position. In other words, in this apparatus, the product carriers or the loading rack with the product carriers are or is moved automatically, i.e. in a motorized manner, from the loading trolley into the baking chamber and out of the baking chamber again.

For example, in the case of an in-store baking oven which carries out baking in a retail space while the staff serves the customers, the staff are saved time by the automatic loading of the oven and by the automatic removal of products. However, time still has to be spent moving the loading trolley into the working position, in which the food is transferred automatically into the baking chamber, and moving the same out of the working position into a cooling position where the food can cool before being sold to customers.

In the case of production baking ovens, the transport trolleys are referred to as rack trolleys and, together with the product carriers accommodated therein, are moved completely into the baking chamber of the baking oven. A baking oven of the applicant, which is heated with hot air and is entered by the rack trolley, is known from WO 2008/034763 A1. Baking ovens heated with thermal oil are also known, which are entered by the transport trolleys together with the product carriers and the products resting on the latter. An oven of this type is also referred to as a trolley oven.

It is the object of the system described herein to further relieve the load on the staff.

### SUMMARY OF THE INVENTION

The apparatus may have at least one movable drive unit which may be couplable or coupled to the transport trolley, and which may have a navigation system and may be configured to move the transport trolley automatically into the first working position.

In other words, a drive may be integrated in the transport trolley (loading trolley or rack trolley) or, in the lower region of the transport trolley, to provide a coupling means which may be couplable to a drive unit with a navigation system. Movable drive units of this type are called AGV (automated guided vehicle) or driverless transport vehicle in the technical terminology. They include a housing which accommodates an electrical drive motor which drives drive rollers. Furthermore, non-driven running rollers may be provided which reliably support the drive unit on the floor. At least one of the rollers may be steered by a steering drive in order to steer the drive unit to a desired position. The use of a driverless transport vehicle in conjunction with a baking apparatus or another food treatment apparatus may reduce the use of staff for treating the foods to a minimum. The AGVs may move a transport trolley automatically from an assignment station, where, for example, the product carriers may be loaded with food, to the treatment unit in order to transfer the product carriers into the treatment chamber of the treatment unit.

The apparatus may have a plurality of treatment units. A treatment unit may be, for example, a proofing cabinet in which dough pieces prove. A treatment unit also may be a baking oven in which dough pieces are thermally treated. The baking oven may be configured as an in-store baking oven into which transport racks are pushed from the transport trolley. In this case, the working position assigned to the baking oven may be in front of the baking chamber. Alternatively or additionally, the baking oven may be configured as a trolley baking oven which the transport trolley completely enters. In this case, the working position may be located within the baking oven. The apparatus may have further working positions or working stations, such as, for example, a cooling station, in which treated bakery products cool, and a retail station, in which finished bakery products are placed into storage containers for removal by customers. The transport trolley with or without a transport rack and baking product carrier also may be transported into a cleaning apparatus in which said transport trolley may be cleaned, for example, overnight.

It is pointed out that the term “transport rack” in this text refers both to a fixed rack of a transport trolley and to a movable loading rack arranged in the fixed rack. Irrespective of how the bakery products are introduced into the baking oven or removed therefrom, the transport trolley carrying the bakery products may be moved into the working position at or in the oven by means of the drive unit described here.

The AGV may arrest the transport trolley in the first working position by a drive motor of the AGV blocking the drive rollers or drive wheels of the AGV in one position. In this way, the coupling of the transport trolley to the treatment unit as known from the prior art (WO 2017 194 403 A1) may be omitted. The AGV may block the transport trolley in the first working position such that said transport trolley does not move during the transfer of the bakery products from the transport trolley into the treatment unit or vice versa. A guide device may be provided on the treatment unit or in the vicinity thereof such that the transport trolley may be guided into the first working position in which it is held by the drive motor of the AGV. The guide unit may be provided, for example, on the treatment unit or in the running surface for the guide rollers.

When the transport trolley is rolled into the treatment unit, in particular in the case of a baking oven, the drive unit may have a telescopic coupling device which pushes the transport trolley into the treatment unit and pulls same out of the treatment unit while the movable drive unit is located outside the treatment unit. In particular when the working position is located in a baking chamber of a baking oven, the fact that the drive unit remains outside the baking oven may protect said drive unit from heat damage. The climate, which may be very moist in chillers or proofing chambers, also may be unfavorable for the drive unit, and therefore it also may be advantageous here to push the transport trolley in while the drive unit remains outside the treatment chamber. In practice, the rollers may be blocked by decoupling the coupling means of the drive unit, and therefore the transport trolley may be stationary without the drive unit coupled thereto and may no longer roll away. The transport trolley may have, for example, a spring-loaded parking brake which may be released when a drive unit is coupled to the transport trolley. This ensures, for example, that a transport trolley which has entered the baking chamber of a baking oven remains in its position and does not inadvertently move.

The apparatus may have a plurality of transport trolleys which each may have a coupling means for a drive unit. In principle, one drive unit may move all of the transport trolleys selectively into the various working positions. However, it also may be possible for a plurality of AGVs to be available which are couplable to a plurality of transport trolleys. Bottlenecks during the simultaneous movement of the transport trolleys thus may be avoided. The lower portion of each transport trolley may have a receiving region into which the drive unit may be moved. The receiving region may have mechanical coupling means with which the drive unit may be coupled mechanically to the transport trolleys. The drive unit may have to accelerate, brake and steer the transport trolley, and therefore the mechanical coupling means may have both to ensure a secure connection in the longitudinal direction of the drive unit and to reliably transmit transverse forces and torques for steering purposes. The mechanical coupling may be undertaken by complementary coupling means intermeshing in a form-fitting manner. A locking means also may be usefully provided on the drive unit, said locking means locking the mechanical coupling and unlocking same when the drive unit is detached from the trolley. Furthermore, electrical coupling means for electrically coupling the drive unit to the transport trolley may be provided. For example, electrical contacts may be provided on the transport trolley, which interact with complementary contacts on the drive unit and produce an electrical connection to the power supply, in particular the battery of the drive unit. Alternatively, contactless electrical coupling means, such as, for example, inductive means for transmitting power to the drive unit, also may be provided, which induce a current in a receiving antenna on the transport trolley and thereby transmit the required electrical power. The inductive electrical coupling means alternatively may be arranged on the baking oven.

It also may be possible for each transport trolley to have its own fixedly coupled drive unit. Whereas, in the case of the couplable drive unit, the transport trolley may have its own rollers so that it also may be displaced manually, in the case of the fixedly coupled drive unit, the rollers thereof may form the rollers of the transport trolley. However, this solution may be not expedient if the transport trolley remains in the treatment unit, for example, during baking or proving of the product. In this case, a releasable transport trolley may be desirable.

The navigation system used may be any navigation system known for AGVs. For example, conductor loops in the floor may enable the navigation. Methods, such as grid navigation or laser navigation, also may be used. A method, such as laser navigation, in which the location is determined and obstacles identified by scanning the surroundings, may have the advantage that it manages without additional installations, such as conductor loops, and may be used in existing food processing plants without costly structural retrofitting. In practice, this method is referred to as SLAM (simultaneous localization and mapping) and serves for the simultaneous determining of the position and for mapping. By scanning the surroundings with laser beams, the surroundings may be detected (mapping) and the position in the surroundings may be determined. Certain properties of the scanned surfaces, in particular of the treatment units and of the trolleys, facilitate the determining of the position and navigation. In addition, mechanical guide elements may be arranged, in particular close to the working positions, the guide elements guiding the movement of the drive unit or of the transport trolleys such that the working positions are reliably reached.

The various components of the apparatus may be provided with data interfaces which permit data communication. In particular, the treatment unit (baking oven), the transport trolley, the drive unit and the navigation system may have such data interfaces. A complete interlinking of the installation makes it possible to know at all times how the various working stations of the apparatus are occupied. By means of automatic identification of the foods introduced into the treatment unit, the optimum baking program or treatment program for the foods may be selected. The treatment unit may be prepared for the upcoming treatment. For example, a baking oven may be pre-heated to the correct temperature before being loaded with dough pieces.

In addition, it may be made possible by means of the data interfaces for the various components of the apparatus to be actuated in a synchronized manner with one another. The treatment chamber, in particular the baking chamber of a baking oven or the proofing chamber of a proofing cabinet, may have a door which is provided with a door drive for automatic opening and closing of said door. Signals transmitted via the data interfaces may announce the arrival of a transport trolley so that the door may be opened shortly before the transport trolley reaches the working position. Sliding contacts or plug contacts may be used for the data transmission. However, wireless data interfaces operating, for example, according to a WLAN or Bluetooth standard, may be usefully used.

The loading drive which transfers the foods from the transport trolley into the treatment unit and back may be arranged directly on the transport trolley itself. This may be advantageous in particular if the transport trolley itself has the drive unit. If the drive unit is coupled to the transport trolley, the loading drive may be provided on the drive unit. Finally, the loading drive may be arranged on the treatment unit (the baking oven) and connected to the transport trolley during the coupling thereof.

### BRIEF DESCRIPTION OF THE DRAWINGS

Further practical embodiments and advantages of the system described herein are described below in conjunction with the drawings, in which:

FIG. 1 shows the sequences during loading of an oven according to a prior art method;

FIGS. 2-6 show a transport trolley with a drive unit according to embodiments of the system described herein, in various views;

FIG. 7 shows the transport trolley without a drive unit from FIGS. 2 to 6, according to embodiments of the system described herein;

FIG. 8 shows a floor plan of a work room of a bakery in which a method of the described here may be realized, according to embodiments of the system described herein;

FIG. 9 shows the floor plan from FIG. 8 with transport trolleys at various working positions, according to embodiments of the system described herein;

FIG. 10 shows a front view of a transport trolley which is intended to be pushed into a baking chamber, according to embodiments of the system described herein;

FIG. 11 shows a side view of the transport trolley from FIG. 10, according to embodiments of the system described herein; and

FIG. 12 shows the baking trolley from FIG. 11 coupled to a drive unit, according to embodiments of the system described herein.

### DESCRIPTION OF VARIOUS EMBODIMENTS

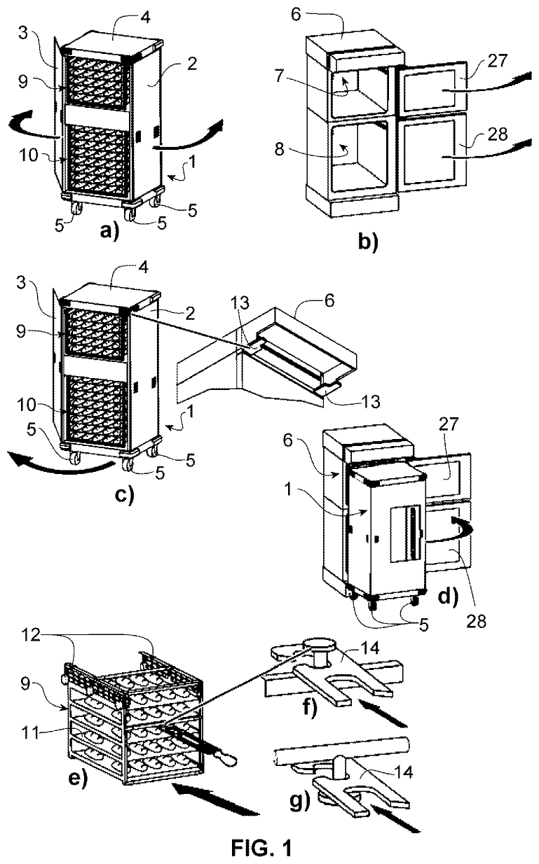

FIG. 1 shows the constituent parts of a conventional manual arrangement for loading a baking oven. Illustration a) of FIG. 1 shows a transport trolley 1 which may be provided here with two pivotable, lateral door panels 2, 3 and a top panel 4. The transport trolley 1 also may be used without door panels and without any cladding at all. On the lower frame of the transport trolley 1 there may be four rollers 5 with which the transport trolley 1 may be moved freely on a flat floor surface.

The illustration b) of FIG. 1 shows a baking oven 6 with two baking chambers 7, 8. The baking chambers 7, 8 may be closed with two pivotable doors 27, 28. Two transport racks 9, 10 may be arranged in the transport trolley 1. Each transport rack 9, 10 may carry product carriers 11 for food products, in the present case bakery products. As explained further above, said transport racks 9, 10 also may be called loading rack in the prior art. In illustration e) which shows the upper loading rack 9, the product carriers 11 may be configured as simple baking trays. In the illustration e), running rollers 12 also may be seen on each side of the transport frame 9, the running rollers facilitating the pushing of the transport rack 9 into and pulling of same out of the transport trolley 1.

The transport rack 10 also may have running rollers.

It can be seen in illustration c) that the upper corners of the transport trolley 1 may be configured in a complementary manner to upper fixing elements 13 above the upper baking chamber 7 of the baking oven 6. The transport trolley 1 may be moved into a position which can be seen in illustration d) of FIG. 1. The transport trolley 1 here may be standing directly in front of the baking chambers 7, 8 of the baking oven 6, and therefore the two transport racks 9, 10 may be pushed into the baking chambers 7, 8. To push them in, the operator may use a loading tool 14 in the form of a long rod with a gripping tool at the end, with which the transport racks 9, 10 may be pushed into the pre-heated baking chambers 7, 8 and may be pulled out of the baking chambers again after the bakery products on the product carriers 11 have been baked. The upper corners of the transport trolley 1 may be held here in the fixing elements 13 and the transport trolley 1 may be fixed against lateral displacement.

As mentioned at the beginning, transport trolleys are also known, for example, from the document WO 2017/194403 A1, in which the transport racks with the product carriers may be pushed out of the transport trolley or may be pulled into the transport trolley automatically, i.e. with an electric motor.

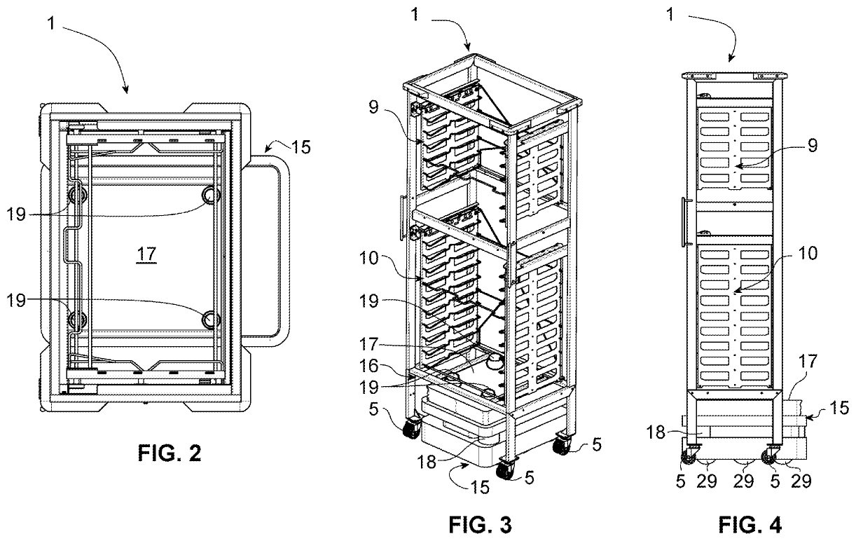

FIGS. 2 to 5 show a transport trolley 1 of this type in which, however, the automatic drive for the transport racks 9, 10 is not illustrated. Any drive means and coupling means, for example electric motors, which move the transport racks 9, 10 via a belt drive or a push rod drive, may be suitable.

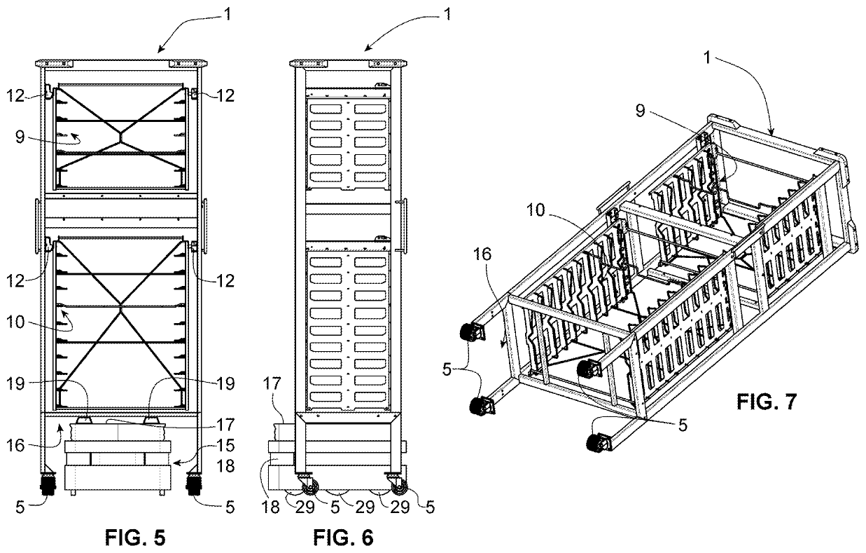

The transport trolley 1 from FIGS. 2 to 6 is intended to be moved automatically. For this purpose, it may be coupled to a driverless transport vehicle, also called AGV. The AGV forms a drive unit 15 which may be accommodated in a receiving region 16 in the lower portion of the transport trolley 1. The drive unit 15 may enter automatically into the receiving region 16 of the transport trolley 1 and may couple there to the transport trolley 1. The drive unit 16 may have an upper covering 17 which may be movable vertically. When the upper covering 17 moves upward, the upper covering 17 may couple in a form-fitting manner to struts of the transport trolley 1 in the receiving region. The coupling may be carried out with displaceable elements to compensate for tolerances. In the embodiment illustrated, rubber frustoconical coupling elements 19 may be on the upper covering and may be moved into receptacles which are formed by the corners between the struts of the transport trolley. In FIG. 5, the covering 17 is illustrated lowered. In this state, the drive unit 15 may be moved into the receiving region 16. The covering may be subsequently moved upward such that the coupling elements 19 move into the corners between the struts of the transport trolley 1 and connect the transport trolley 1 to the drive unit 15 in a form-fitting manner. This state is illustrated in FIGS. 3, 4 and 6.

Alternatively, the coupling elements 19 may engage in round receptacles of the transport trolley. These frustoconical coupling elements 19 may move automatically into their receptacles even if the alignment is imprecise by a few millimeters or even 1 cm because their upper diameter may be smaller than the lower diameter, and they may align the transport trolley 1 with respect to the drive unit 15 during the movement into the receptacles. Furthermore, the coupling elements may be composed of an elastic material, such as hard rubber, in order to absorb excessive forces as the transport trolley is carried along. In principle, any mechanical (e.g., form-fitting) coupling means may be used for coupling the drive unit 15 to the transport trolley 1.

The rollers 29 of the drive unit 15 may be driven by electric motors. The drive unit 15 may have a rechargeable battery, the current of which operates the electric motors and the control electronics of the drive unit 15. The battery of the drive unit 15 may be recharged in a known manner at a charging station.

When the transport trolley 1 is coupled mechanically to the drive unit 15, electrical contacts also may be coupled to one another such that an electrical connection is produced between the battery or the rechargeable battery of the drive unit 15 and the loading drive of the transport trolley 1.

Alternatively, the transport trolley 1 may have electrical contacts which, when the transport trolley 1 moves into the first working position in front of the baking oven 6, make contact with an electrical contact arranged there and ensure the power supply of the loading drives from the baking oven 6.

On the front side and on the rear side, the drive unit 15 may have a scanning laser 18 which scans the space in front of it. For mapping the space in front of the scanning lasers 18, the drive unit 15 may be equipped with a powerful processor. It therefore may be possible for the drive unit 15 also to take on the control of the loading drive of the transport trolley 1. For this purpose, the electrical coupling means also may have to couple signal channels to one another, permitting the transmission of control signals, for example for the loading drives of the transport trolley 1.

In FIG. 7, the transport trolley 1 is illustrated horizontally. The lower region of the transport trolley 1 may form the receiving region 16 for the drive unit 15. The transport trolley 1 also may be connected permanently to the drive unit 15. In this case, the rollers 5 at the lower ends of the lateral columns of the transport trolley 1 are omitted, and the rollers 29 of the drive unit 15 in this case may form the rollers of the transport trolley 1.

The couplable embodiment of the transport trolley 1 may have the advantage that a multiplicity of transport trolleys 1 may be moved with very few drive units 15. If the drive units 15 fail, the transport trolleys 1 also may continue to be displaced manually. In addition, as described further below, the transport trolley 1 may be enabled to move, for example, into the baking chamber of a baking oven and to reside there for heat treatment without the drive unit 15 being moved into the baking chamber.

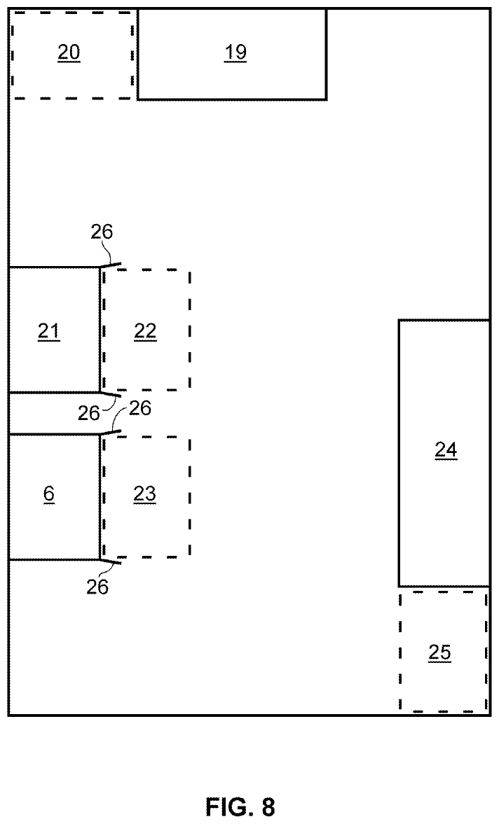

The floor plan of a work room of a bakery, in which the method described here may be implemented, can be seen in FIG. 8. The work room may have an assignment table 30 on which bakery products may be prepared and placed onto baking trays. Next to the assignment table 30 there may be a working position 20 for a transport trolley 1. Furthermore, the work room may have a proofing cabinet 21 in front of which a further working position 22 may be provided. Furthermore, next to the proofing cabinet 21 there may be a baking oven 6, in front of the front side of which in turn a working position 23 may be provided. On the opposite side of the work room there may be a sales counter 25, next to which in turn a working position 24 may be provided.

The various working positions and the associated treatment units or work stations may be provided at different locations, depending on the spatial circumstances of the work room.

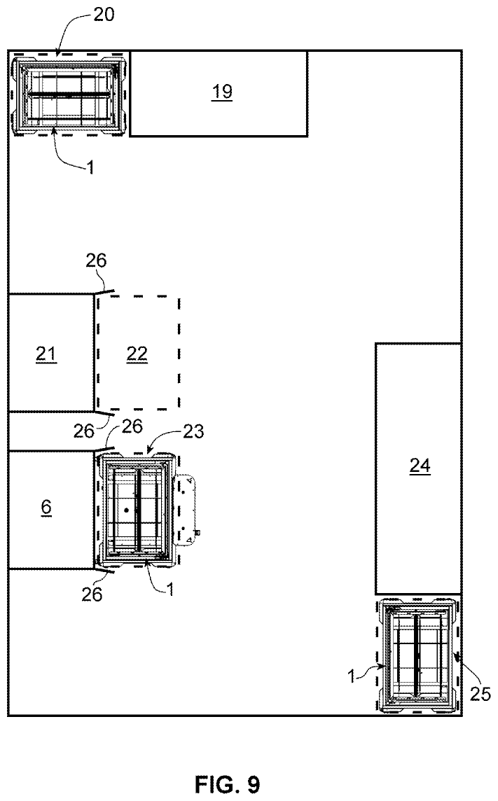

In FIG. 9, a first transport trolley 1 may be arranged in the first working position 20 next to the assignment table 30. This trolley may be placed there for a prolonged period of time. It is not currently coupled to a drive unit. The staff may prepare the bakery products, place them on baking trays and may push the baking trays into the transport racks of the transport trolley.

A transport trolley 1 which is not coupled to a drive unit also may be placed in the fourth working position 25.

By contrast, in the third working position 23 there may be a transport trolley 1 which may be coupled to a drive unit 15. The drive unit 15 may have been used to move the transport trolley 1 either from the first working position 20 or from the second working position 22 to the third working position 23. Here, the transport racks 9, 10 may be moved out of the transport trolley 1 into the baking chambers of the baking oven 6. So that the transport trolley 1 is aligned exactly with the baking oven 6 during this procedure, the drive unit 15 may remain coupled to the transport trolley 1 and block the rotation of the rollers or wheels of the drive unit 15.

It can be seen that fixing bars 26 may be arranged both in front of the proofing cabinet 21 and in front of the baking oven 6, said fixing bars 26 aligning the front side of the transport trolley 1 with the opposite front side of the proofing cabinet 21 or of the baking oven 6 as the transport trolley 1 approaches the proofing cabinet 21 or the baking oven 6. The function of the fixing bars 26 corresponds substantially to that of the fixing element 13 from FIG. 1. The fixing bars 26 may ensure the positionally precise arrangement of the transport trolley 1 in front of the proofing cabinet 21 or the baking oven 6 and ensure the fault-free movement of the transport rack 9, 10 from the transport trolley 1 into the proofing cabinet 21 or the baking oven 6 and back again.

At the other working positions 20, 25, precise positioning may be less important because the baking product carriers 11 may be inserted into the transport racks 9 and 10 and removed therefrom individually and manually. A reason why it may be desirable to not provide the transport trolley 1 in the present method with wall panels at least on the front side and rear side is apparent from FIG. 8. With an open transport trolley 1, the baking product carrier 11 may be introduced from both sides. It also may be possible to configure the loading drive in such a manner that the transport rack 9, 10 may be moved out of the transport trolley 1 in both directions. With such structural conditions, it may be possible to equip the transport trolley 1 with baking product carriers and bakery products from one side and to push the equipped transport rack 9, 10 out on the other side in order to feed said transport rack to the treatment unit, which may reduce the need for turning operations which may be required for moving the transport trolley 1 to all working positions 20, 22, 23, 25 in a complex work room.

Of course, the system described here also may be suitable for work rooms which are separated from retail spaces. Further treatment units, such as, for example, packaging machines, also may be provided, to which the transport trolleys 1 may be moved.

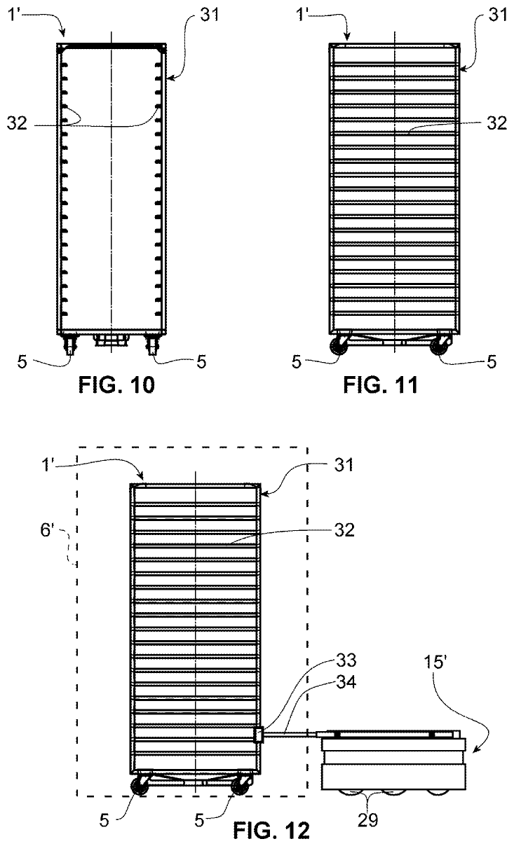

As an alternative to a transport trolley 1 with transport racks 9, 10, use also may be made of a transport trolley 1′ which is illustrated in FIGS. 10 to 12 and may be pushed together with the product carriers into a baking oven in order to bake the products transported by the transport trolley 1′. It can be seen in FIGS. 10 and 11 that the transport trolley 1′ may be composed of a rack 31 of steel tubes on which rails 32 may be in each case arranged in pairs opposite one another, into which baking trays (not illustrated) as product carriers may be pushed. In order to arrange as many products as possible on the transport trolley 1′, the rails 32 may reach into the lower region of the transport trolley 1′ close to the rollers 5. There also may be no receiving region. Instead, the drive unit 15′ may couple by means of gripping elements 33 directly to the rack 31 of the transport trolley 1′, and said rack as a transport rack for the product carriers may enter completely into the baking chamber of the trolley oven 6′. It can be seen in FIG. 12 that the gripping elements 33 may be arranged on a telescopically extendable rod 34 which may be fastened to the drive unit 15′ and, together with the gripping elements, forms a telescopic coupling device. The gripping element 33 may be detached from the transport trolley 1′, for example in order to place the latter in a treatment unit 6′ (trolley baking oven), with the drive unit 15′ remaining outside the treatment unit 6′. The transport trolleys 1′ thus may be moved into and out of the trolley baking oven 6′ without the drive unit 15′ and the rollers 29 thereof being moved into the trolley baking oven 6′ and being exposed there to the high heat. When the gripping elements 33 are detached from the rack 31 of the transport trolley 1′, a parking brake (not illustrated) may be activated in order to avoid the transport trolley 1′ rolling on.

The features of the invention that are disclosed in the present description, in the drawings and in the claims may be essential both individually and in any combinations for implementing the system described herein in its various embodiments. The invention is not restricted to the described embodiments, and may be varied within the scope of the claims and taking into consideration the knowledge of the relevant person skilled in the art. Other embodiments of the system described herein will be apparent to those skilled in the art from a consideration of the specification and/or an attempt to put into practice the system described herein disclosed herein. It is intended that the specification and examples be considered as illustrative only, with the true scope and spirit of the invention being indicated by the following claims.

1. An apparatus for treating foods, comprising:
at least a first treatment unit which has at least a first treatment chamber which is configured to receive product carriers with foods
at least a first transport trolley which has rollers and at least ene a first transport rack for a plurality of product carriers, which can be introduced into the first treatment chamber, and which can be rolled into a first working position at the first treatment unit; and
at least a first movable drive unit which is couplable or coupled to the first transport trolley, wherein the at least first movable drive unit has a navigation system and is configured to move the first transport trolley automatically at least into the first working position.

2. The apparatus of claim 1, wherein the first transport trolley in the first working position is aligned with the first treatment unit in order to move the product carriers or the first transport rack with product carriers from the first transport trolley to the first treatment unit or back, and
wherein the apparatus further comprises a loading drive for moving a loading rack or the product carriers between the first treatment unit and the first transport trolley when the first transport trolley is in the first working position.

3. The apparatus of claim 1, wherein the first working position is within the first treatment unit.

4. The apparatus of claim 3, wherein the first movable drive unit has a telescopic coupling device which pushes the first transport trolley into the first treatment unit and pulls same out of the first treatment unit while the first movable drive unit is located outside the first treatment unit.

5. The apparatus of claim 1, wherein the at least first transport trolley includes a plurality of transport trolleys, and wherein the at least first movable drive unit is couplable to each of the plurality of transport trolleys.

6. The apparatus of claim 1, wherein a lower portion of each of the at least first transport trolley has a receiving region into which the at least first movable drive unit can be moved.

7. The apparatus of claim 6, wherein the receiving region has at least one of the following:
mechanical coupling means for mechanically coupling the at least first movable drive unit to the at least first transport trolley; and
electrical coupling means for electrically coupling the at least first movable drive unit to the at least first transport trolley.

8. The apparatus of claim 7, wherein the at least first transport trolley includes a plurality of transport trolleys, and each transport trolley is coupled to a respective one of the at least first movable drive unit.

9. The apparatus of claim 1, wherein said apparatus has at least one further working position, and the at least first movable drive unit and the navigation system of the at least first movable drive unit are configured to move the at least one transport trolley automatically into the at least one further working position.

10. The apparatus of claim 1, wherein at least two of the following units are provided with data interfaces for data communication:
the at least first treatment unit;
the at least first transport trolley;
the at least first movable drive unit; and
the navigation system of the at least first movable drive unit.

11. The apparatus of claim 1, wherein the at least first treatment chamber has a door which is provided with a door drive for automatically opening and closing said door.

12. The apparatus of claim 2, wherein the loading drive is arranged on one of the following:
on the at least first treatment unit,
on the at least first transport trolley, and
on the at least first movable drive unit.

13. The apparatus as claimed in claim 12, wherein the loading drive and electrical coupling means for a power supply of the loading drive are arranged on the at least first transport trolley and are couplable to complementary electrical coupling means on the at least first movable drive unit or on the at least first treatment unit.

14. A method for the loading of a treatment unit for foods, which treatment unit has at least one treatment chamber which is configured to receive product carriers with foods, comprising:
at least one transport trolley which has at least one transport rack for a plurality of product carriers and rollers is rolled into a first working position at the treatment unit; and
at least one drive unit which has a navigation system and is couplable or coupled to the transport trolley, moving the at least one transport trolley automatically at least into the first working position.

15. The method of claim 14, wherein the at least one transport trolley in a first working position is positioned close to the treatment unit in order to move the plurality of product carriers or the transport rack with product carriers from the at least one transport trolley to the treatment unit or back by means of a loading drive.

16. The method of claim 14, wherein the movable drive unit has a telescopic coupling device which pushes the transport trolley into the treatment unit and pulls same out of the treatment unit while the movable drive unit is located outside the treatment unit.

17. The method of claim 14, wherein there are a plurality of transport trolleys, and in that wherein the drive unit is selectively coupled to each of the transport trolleys.

18. The method of claim 14, further comprising;
moving the transport trolley automatically into at least one further working position.

19. The method of claim 14, wherein at least two of the following units communicate with one another via data interfaces:
the at least one treatment unit;
the at least one transport trolley;
the at least one movable drive unit; and
the navigation system of the at least one movable drive unit.

20. The method as claimed in claim 19, further comprising:
transmitting a signal for actuating a door of the treatment chamber to the treatment unit via the data interface.
